(19) United States
(12) Patent Application Publication
(10) Pub. No.: US 2020/0091754 A1
(43) Pub. Date: Mar. 19, 2020

(54) LOW-ENERGY-CONSUMPTION HIGH-FREQUENCY WIRELESS CHARGING SYSTEM FOR LITHIUM BATTERY

(71) Applicant: NEWVASTEK CO., LTD., New Taipei City (TW)

(72) Inventors: Ming Liu, New Taipei City (TW); Chengbin Ma, New Taipei City (TW); Ming-Liang Fang, New Taipei City (TW); Chih-Hao Chuang, New Taipei City (TW)

(21) Appl. No.: 16/132,482

(22) Filed: Sep. 17, 2018

(51) Int. Cl. H02J 7/02; H01M 10/0525; H01M 10/44; H02J 50/12

(52) U.S. Cl. CPC H02J 7/025; H02J 50/12; H01M 10/44; H01M 10/0525

(57) ABSTRACT

A low-energy-consumption high-frequency wireless charging system for a lithium battery, the main structure comprises a power-supply module connected in series with a first resonant unit; wherein the first resonant unit is electrically connected to a resonance-tuning module; wherein the resonance-tuning module comprises a first shunt unit and a second resonant unit both electrically connected with the first resonant unit; and the first shunt unit is electrically connected to a third resonant unit and a rectifier module; wherein the third resonant unit is connected in parallel with the rectifier module; and the rectifier module is electrically connected with a voltage stabilizing module which is connected in parallel with a power-storage element. When the power-storage element is charging, the resonance-tuning module has a charging curve with better efficiency to achieve the effect of Class-E wireless fast charging.

### (a) TECHNICAL FIELD OF THE INVENTION

The present invention provides a low-energy-consumption high-frequency wireless charging system for a lithium battery, in particular, to a low-energy-consumption high-frequency wireless charging system with a better charging curve and capable of directly charging a lithium battery rapidly.

### (b) DESCRIPTION OF THE PRIOR ART

In recent years, the Wireless Power Transmission (WPT) which is coupled by the inductive resonance has become popular; and various electronic devices (for example, mobile phones, notebook computers, wearable devices, and medical implanted devices) and even the electric vehicles being charged.

For WPTs operating at high power in kilohertz (kHz), there are rapid advances in coil design, compensation topology, and control strategies.

At the same time, in order to reduce the size and weight of the WPT system, it is preferable to further increase the operating frequency to a few megahertz (MHz), such as 6.78 and 13.56 MHz. Higher operating frequencies help to increase spatial freedom, i.e. longer transmission distance and higher coupling coil alignment tolerance, which is particularly advantageous for charging mobile devices.

However, when operating at the operating frequency of MHz, the power capability of the switching device may be insufficient.

Currently, the megahertz WPT is generally considered suitable for the medium power and low power applications. For the MHz WPT, the high switching losses will occur when using conventional power amplifiers (PAs) and rectifiers.

Since Class-E power amplifier and rectifier are expected to be candidates for building the high efficiency MHz WPT system due to their soft switching characteristic. Among them, Class-E power amplifier was first applied to the MHz WPT system and improved due to its high efficiency and simple topology. Similarly, Class-E power amplifier has also been proposed for use in the high frequency rectification.

About the application research in WPT, According to reports, the efficiency of the rectifier is as high as 94.43% at the 800 kHz operating frequency. Therefore, the combination of Class-E power amplifier and rectifier (i.e., Class-E converter) is expected to realize the high efficient wireless charging system operating in MHz.

Because the high energy density of the lithium-ion battery, it is now widely used in the consumer electronics, the typical charging curve of a lithium-ion battery is usually composed of two modes: the Constant-Current (CC) mode and Constant-Voltage (CV) mode. In order to extend the battery cycle life, the battery is first charged in the CC mode, when its voltage reaches a standard value, the charging system enters the CV mode, and the charging current drops rapidly. That is, the wireless charging system must accurately supply current and voltage according to a specific battery charging curve.

In the practical application, the charging configuration can be monitored by the input voltage control of the charging system or the regulation circuit between the charger and the battery. In a conventional Class-E converter for the WPT application, the system parameters are only for a single specific operating condition to do the optimization. The optimization is to fix the relative position of the coil and the final load. However, unlike the conventional constant resistance load, the voltage and current of the battery will vary with the charging curve.

In the practical application, the charging configuration can be monitored by the input voltage control of the charging system or the regulation circuit between the charger and the battery. In a conventional Class-E converter for the WPT application, the system parameters are only for a single specific operating condition to do the optimization. The optimization is to fix the relative position of the coil and the final load. However, unlike the conventional constant resistance load, the voltage and current of the battery will vary with the charging curve.

In addition, the input reactance of the Class-E rectifier is not negligible at MHz and will vary with the variance of the battery voltage and current. This apparent and varying input reactance of the Class-E rectifier increases the power loss and results in the design complication for the high efficiency MHz Class-E wireless battery charging system.

Due to the non-negligible and varying input reactance of the class-E rectifier, those present methods have been ineffective for the Class-E wireless battery charging system.

### SUMMARY OF THE INVENTION

The main purpose of the present invention is to minimize the energy loss of the MHz Class-E2 wireless battery charging system during the entire charging cycle, which the average power loss is defined and calculated based on a discretized battery charging profile and a system efficiency analytically derived. And, this average power loss is used as the objective function which is minimized through the parameter design based on the proposed battery charging profile, such that the low energy consumption can be achieved for a specific charging profile.

Therefore, the main purpose of the present invention is to resonance-tune the charging curve of a lithium battery by adding a first shunt unit and a second resonant unit, thereby directly performing a Class-E wireless fast charging of a lithium battery with low power loss and high charging efficiency.

To achieve the above objective, the main structure of the present invention comprises: a power-supply module, a first resonant unit connected in series with the power-supply module, a resonance-tuning module located at one side of and electrically connected to the first resonant unit, a second shunt unit electrically connected with the resonance-tuning module, a third resonant unit electrically connected to one end of the second shunt unit, a rectifier module, a voltage stabilizing module located at one side of and electrically connected to the rectifier module, a power-storage element connected in parallel with the voltage stabilizing module, and a grounding portion connected to one side of the power-storage element, wherein the resonance-tuning module comprises a second resonant unit electrically connected with the first resonant unit and a first shunt unit.

With the above structure, the user can supply power through the power-supply module, and the first resonant unit cooperates with the third resonant unit to resonance-tune the rectifier module to stabilize the current, and the current is reflowed through the second shunt unit. The current passed through the rectifier module can have a double efficiency, and the voltage is stabilized by the voltage stabilizing module to charge the power-storage element.

When the voltage in the power-storage element is charged to a certain extent, the constant-current module is changed to a constant-voltage module, and then the first shunt unit and the second resonant unit in the resonance-tuning module can be used for resonance-tuning Therefore, the power-storage element still has a better charging curve when charging is in the constant-voltage power source, so as to achieve a fast charging effect to the power-storage element.

### BRIEF DESCRIPTION OF THE DRAWINGS

FIG. 1 is a block diagram of a preferred embodiment of the present invention.

FIG. 2 is a current flow diagram of a preferred embodiment of the present invention.

FIG. 3 is a charging efficiency curve diagram of a preferred embodiment of the present invention.

FIG. 4 is a power loss curve diagram of a preferred embodiment of the present invention.

FIG. 5 is a schematic diagram of a Class-E wireless battery charging system of a preferred embodiment of the present invention.

FIG. 6 is a charging curve schematic diagram of a lithium battery of a preferred embodiment of the present invention.

FIG. 7 is an impedance schematic diagram of a preferred embodiment of the present invention.

FIG. 8 is a coupled coil efficiency (ηcoil) schematic diagram of a preferred embodiment of the present invention.

FIG. 9 is an input impedance schematic diagram of a preferred embodiment of the present invention.

FIG. 10 is a LC matching network schematic diagram of a preferred embodiment of the present invention.

FIG. 11 is a relation block diagram of a preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims.

The foregoing and other aspects, features, and utilities of the present invention will be best understood from the following detailed description of the preferred embodiments when read in conjunction with the accompanying drawings.

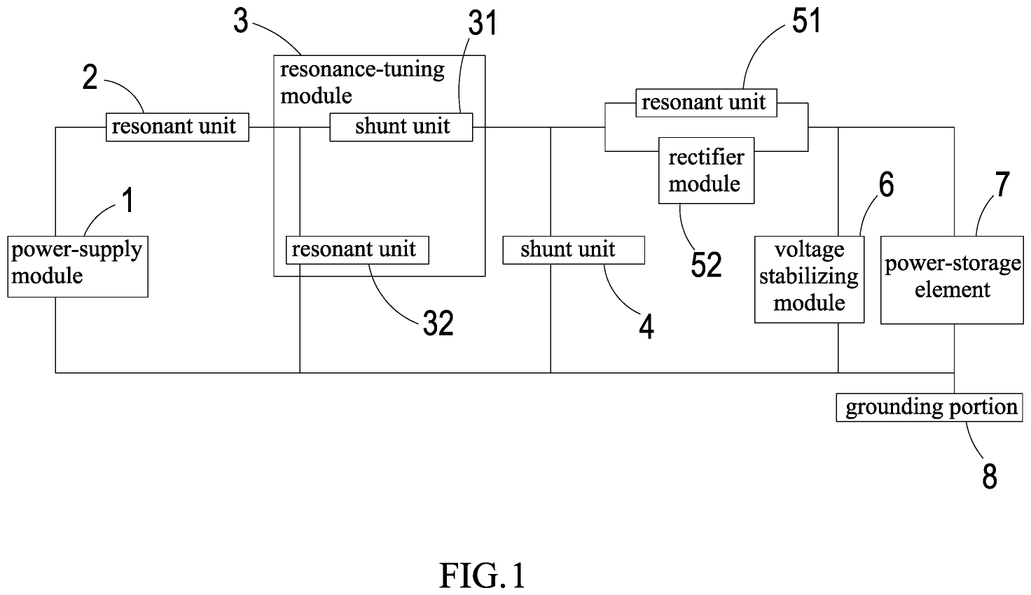

Please refer to FIG. 1 the first embodiment which is a block diagram of a preferred embodiment of the present invention, it is apparent from the drawing that the present invention comprises: a power-supply module 1, a first resonant unit 2, a t resonance-tuning module 3, a second shunt unit 4, a third resonant unit 51, a rectifier module 52, a voltage stabilizing module 6, and a power-storage element 7, and a grounding portion 8; wherein the power-supply module 1 is an inductor (Inductance) that receives power through a wireless sensing method; wherein the first resonant unit 2 is connected in series with the power-supply module 1, and the first resonant unit 2 is a capacitor (Capacitance); wherein the resonance-tuning module 3 is located at one side of the first resonant unit 2, and the resonance-tuning module 3 comprises a second resonant unit 32 electrically connected with the first resonant unit 2, and a first shunt unit 31 electrically connected with the first resonant unit 2; wherein the resonant unit 32 is a capacitor (capacitance) and the first shunt unit 31 is an inductor (inductance); wherein one end of the second shunt unit 4 is electrically connected with the first shunt unit 31, and the second shunt unit 4 is an inductor (inductance); wherein the rectifier module 52 is electrically connected with one end of the first shunt unit 31 away from the first resonant unit 2; wherein the third resonant unit 51 is connected in parallel with the rectifier module 52, and the third resonant unit 51 is a capacitor (capacitance); wherein the voltage stabilizing module 6 is electrically connected to one end of the rectifier module 52, and the voltage stabilizing module 6 is a voltage stabilizing capacitor; wherein the power-storage element 7 is connected in parallel with the voltage stabilizing module 6, and the power-storage element 7 is a DC battery; wherein the grounding portion 8 is connected with one side of the power-storage element 7.

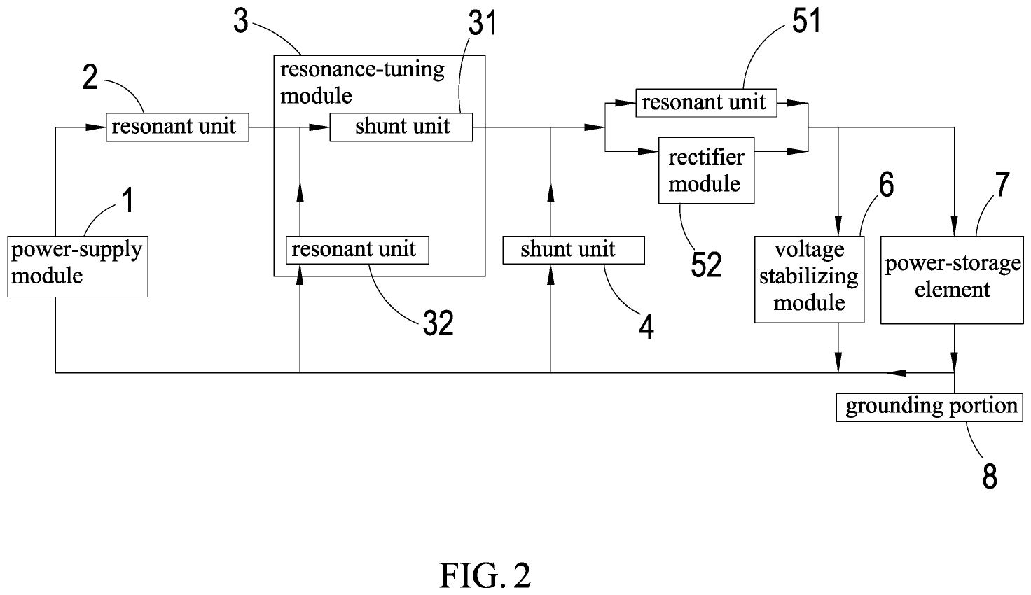

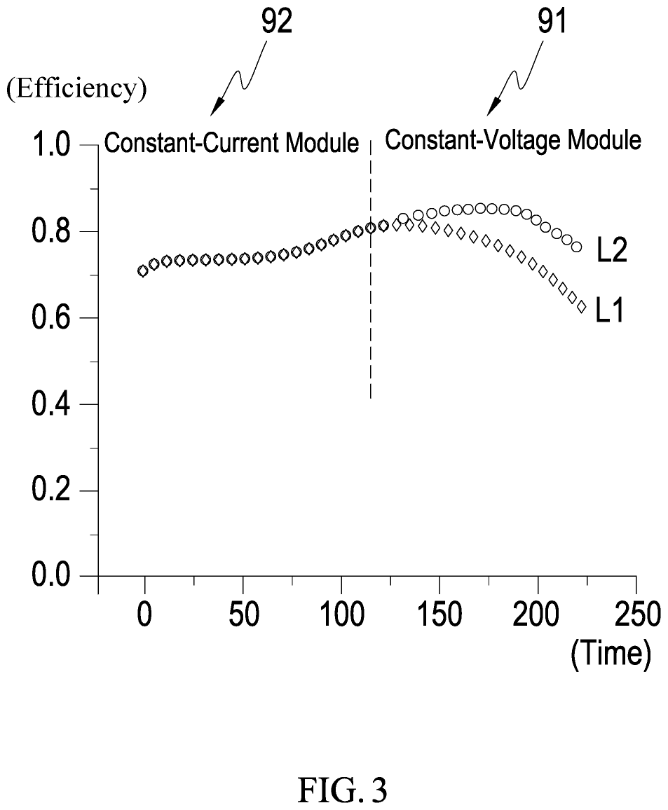

Please simultaneously refer to FIG. 1 to FIG. 11, which are the schematic block diagrams to the relation block diagrams of the preferred embodiment of the present invention. When the above components are assembled, it can be clearly seen from the figures that the user utilizes the wireless electromagnetic wave senses the power-supply module 1 to supply power, and the first resonant unit 2 and the third resonant unit 51 modulate the passed current to reduce the electromagnetic interference (EMI). And, the third resonant unit 51 can also control the frequency of the rectifier module 52, thereby converting the alternating current power source into a direct current power source, and the voltage stabilizing module 6 can stably supply the voltage to the power-storage element 7. In this way, the power-storage element 7 can be charged, and the second shunt unit 4 can re-guide the power of the reflow into the rectifier module 52 to enhance the current passed through the rectifier module 52, thereby increasing the efficiency of charging. When the voltage in the power-storage element 7 reaches a predetermined value, the constant-current module (CC Mode) 92 is changed to the constant-voltage module (CV Mode) 91 as shown in FIG. 3, and the tuning can be utilized at this time. The second resonant unit 32 in the resonance-tuning module 3 is tuned and re-guide the current through the first shunt unit 31, this will make the overall charging curve more stable and will be as shown in FIG. 3.

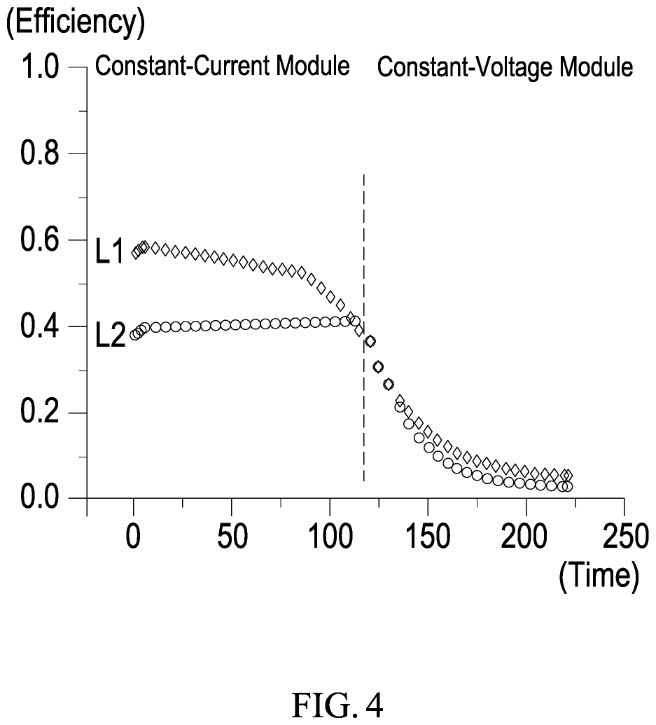

When the conventional charging mode (L1) is changed from the constant-current module (CC Mode) 92 to the constant-voltage module (CV Mode) 91, the efficiency will rapidly decrease with time, so that the fast charging cannot be performed. However, the present invention (L2) cooperates with the second resonant unit 32 via the first shunt unit 31, so that when the overall charging curve is changed to the constant-voltage module (CV Mode) 91 from the constant-current module (CC Mode) 92, it still can have a high-efficiency charging curve and can maintain similar low-efficiency loss as shown in FIG. 4, so that the lithium battery can be performed the low-power loss and high-efficiency class-E wireless fast charging.

The above charging mode is the charging performance generated by the class-E wireless battery charging system cooperated with the resonance-tuning module to produce the high charging efficiency, and the derivation technique and formula are as follows.

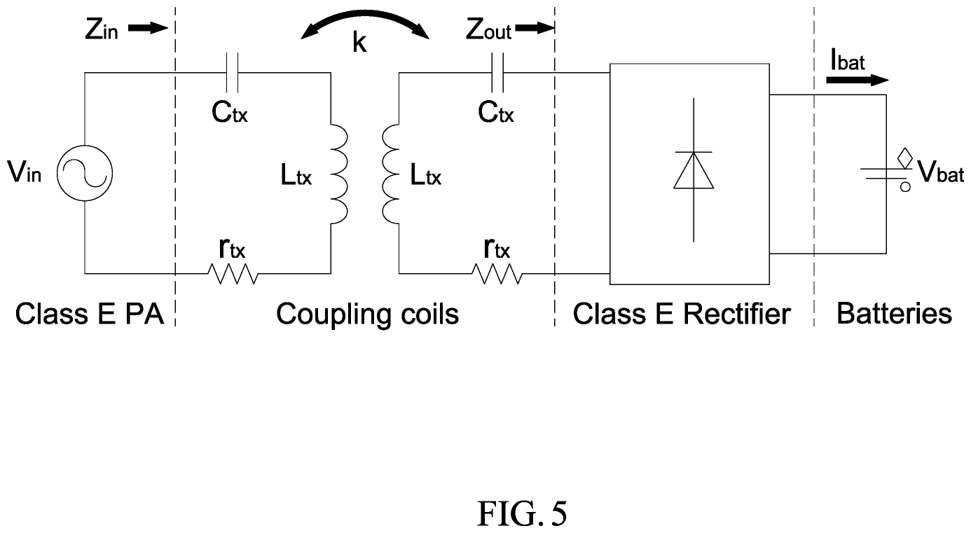

Firstly, please refer to the FIG. 5 for the conventional 6.78-MHz Class-E wireless battery charging system. It consists of a Class-E Power Amplifier (Class-E PA), coupling coils, Class-E rectifier, and lithium battery. Ltx and Lrx represent the transmit and receive coils respectively; rtx and rrx are the Equivalent Series Resistance (ESR) of Ltx and Lrx; Ctx and Crx are the compensation capacitors; Zin is the input impedance of the coupled coil, and Zout is the input impedance seen from the receive coil; Vbat and That are battery voltage and charging current, respectively; and Vin is the output voltage.

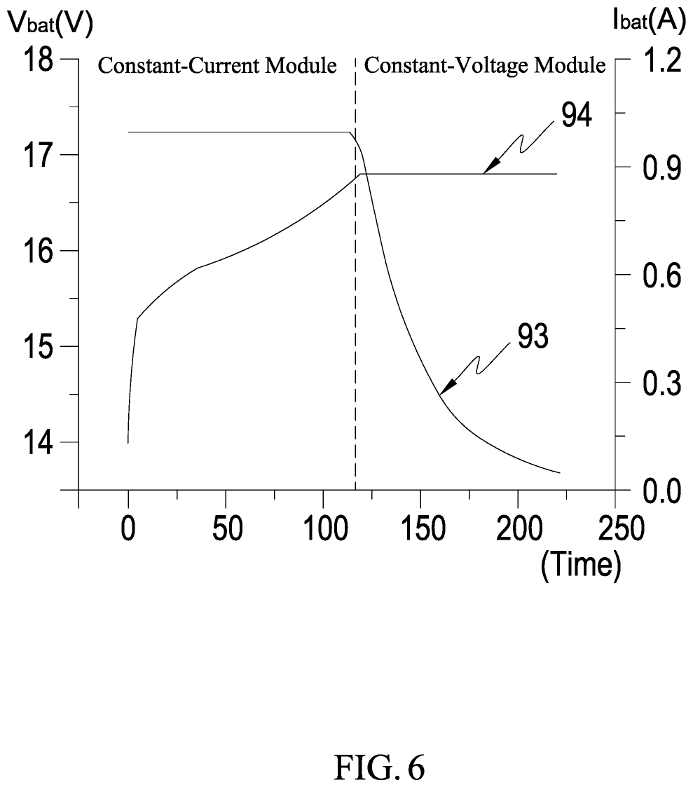

A typical lithium battery charging mode usually consists of two modes, a Constant-Current module (CC Mode) 92 and a Constant-Voltage module (CV Mode) 91. It is expected that the wireless battery charging system will provide accurate charging current and voltage in accordance with the required charging curve, it can be further referred to FIG. 6 again, which is a schematic diagram showing the charging curve of the lithium battery. In the charging curve, the constant charging current is 1 μA, and the constant battery voltage is 16.8 V, which the charging current 93 and the charging voltage 94 are displayed, and the changes in the charging current 93 and the charging voltage 94 will affect the values of Zout and Zin. This in turn affects the efficiency of the coupled coil and the Class-E power amplifier, and the producing influences of the Class-E rectifiers at MHz are more pronounced in the MHz Class-E wireless charging system due to the highly nonlinear behavior of the Class E rectifier operating at MHz.

If a well-known nonlinear radio frequency (RF) circuit simulation software is used, the performance of the classic 6.78-MHz class-E wireless battery charging system is studied, and a half-wave class-E rectifier is used in the analyzation and experiment below, which the same class-E rectifier was used in the experiment.

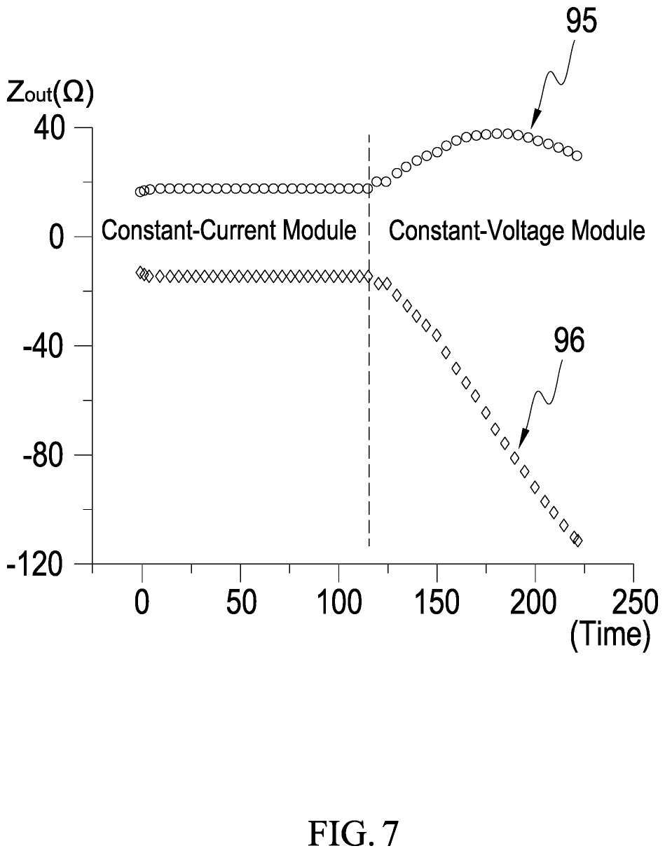

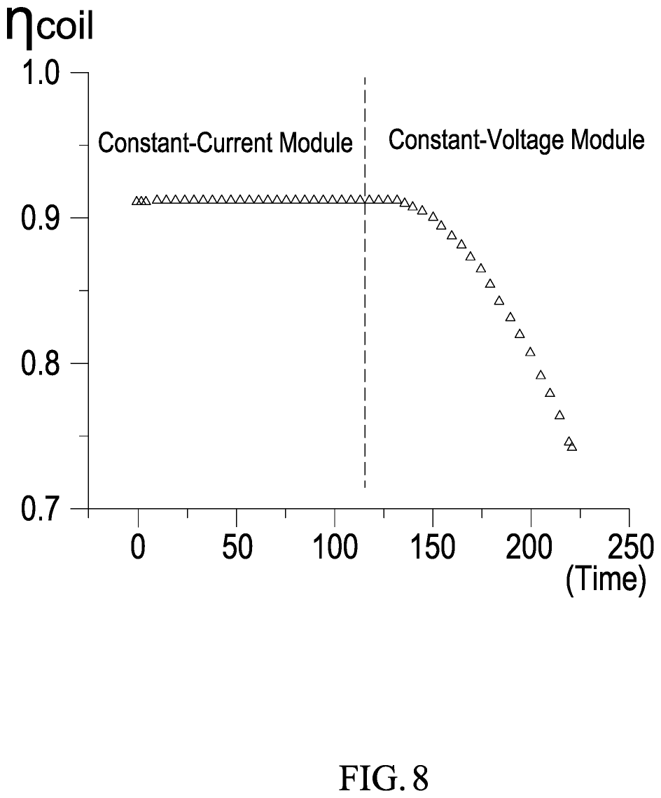

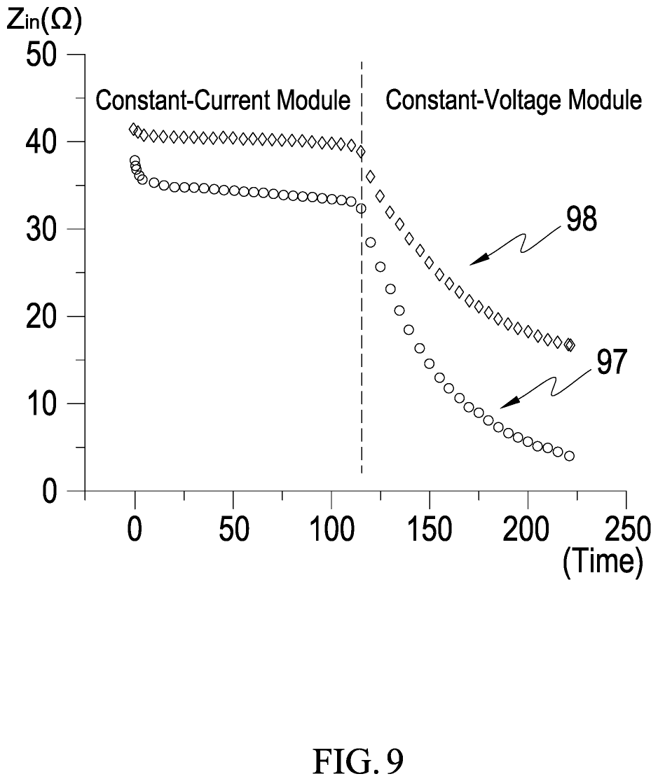

Please simultaneously refer to FIG. 7, the simulation results of the resistor Rout 95 and the output reactance Xout 96 obtained in the charging curve Zout of the FIG. 6 are shown. It can be seen that in the CV mode, the capacitance, i.e., the output reactance Xout 96 increases sharply, and is matched with FIG. 8. It can be known that this output reactance Xout 96 has a significant influence on the efficiency ηcoil and the power transmission capability of the coupled coil, it will make the efficiency ηcoil reduce rapidly. Please simultaneously refer to FIG. 9, it is the simulation result of the input impedance of the coupled coil. Due to the increase of the output reactance Xout 96, the input impedance Zin of the resistor Rin 97 and the input reactance Xin 98 drop rapidly in the CV mode, and the low resistance of the input impedance Zin causes the transmitting coil Ltx of the class E-power amplifier, the equal serial resistance of the transmitting coil rtx, and the component resistance produce high power losses. In addition, the varying resistance Rin 97 and the input reactance Xin 98 (i.e., the load of the PA) may produce a negative influence.

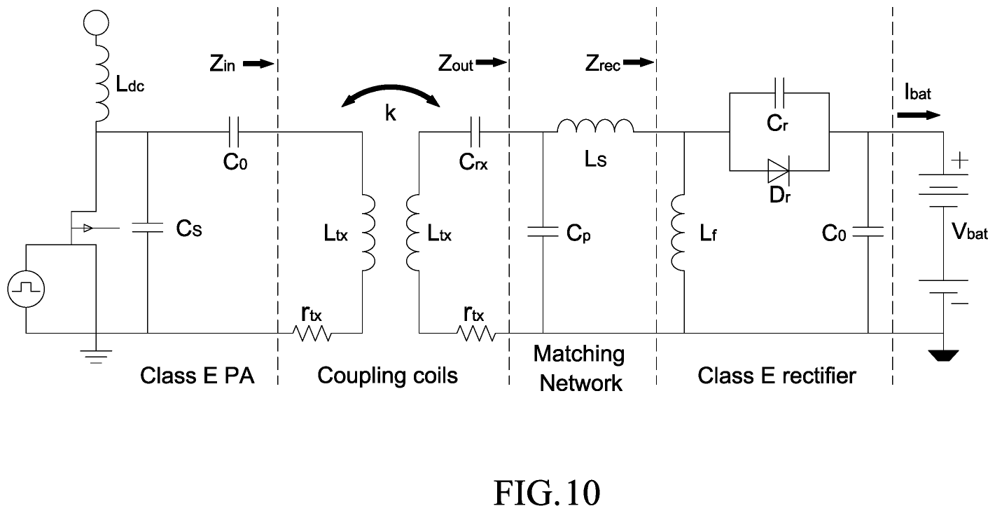

As described above, following the required battery charging curve results in a change in the impedance characteristics, and thus significantly affects the efficiency of the coupled coil and Class-E power amplifier operating at MHz, resulting in a complication of the Class-E wireless charging system. Please refer to FIG. 10. In order to reduce the influences of current change and voltage change of the battery, an LC matching network (Matching Network) can be added to the classic Class-E wireless charging system, which is the resonance-tuning module 3, the LC matching network, of the present invention. The LC matching network (resonance-tuning module 3) is located between the coupling coils and the Class-E rectifier. It improves the load conditions of the Coupling Coils and Class E Power Amplifiers (Class-E PA) and introduces a new design freedom to optimize overall system efficiency under the battery charging characteristics. Wherein the compensation capacitor Ctx of the transmitting coil is absorbed into the class-E power amplifier (Class-E PA). Among the serial capacitors of C0, Ldc and Lf are the DC filter inductors of the class-E power amplifier and the rectifier respectively; and the Cs is the parallel capacitor of the class-E power amplifier. Cr and Co are the shunt capacitor and the DC output capacitor for the class E-rectifier. Ls and Cp are the serial inductance (first shunt unit 31) and the parallel capacitor (second resonanting unit 32) of the LC matching network respectively.

$${η}_{sys} = \frac{4 π {V}_{bat}}{\frac{\begin{matrix}\begin{matrix}Ibat [ ( \text{?} + {r}_{Lx} ) ( {R}_{out} + \text{?} ) ] \\ [ 4 π ( {R}_{dc} + {r}_{{L}_{dc}} ) +\end{matrix} \\ ( 2 π + 8 cos {φ}_{2} g + π {g}^{2} ) \text{?} ]\end{matrix}}{{R}_{out} ( {R}_{in} - {r}_{ix} ) {g}^{2} {sin}^{2} {φ}_{1}} + 4 π [ {I}_{bat} ( {r}_{{L}_{f}} + \text{?} ) + \text{?} ]}$$

$$\text{?} \text{indicates text missing or illegible when filed}$$

The above technique can be implemented with the following formula:

The above formula is Equation 1, which is the relationship between the efficiency ηsys(t) and Ibat(t) and Vbat(t) in the electromagnetic charging;

And at a specific time (t), the output power Po of the charging system is:

Pₒ(t)=I_{bat}(t)V_{bat}(t).

Therefore, the total power loss Ploss at a certain time (t) is:

$${P}_{loss} ( t ) = \frac{{P}_{o} ( t )}{{η}_{sys} ( t )} - {P}_{o} ( t ) = \frac{{I}_{bat} ( t ) {V}_{bat} ( t )}{{η}_{sys} ( t )} [ 1 - {η}_{sys} ( t ) ] .$$

Here the ηsys(t) can be calculated by substituting Ibat(t) and Vbat(t) into Equation 1. After optimizing the calculation, the charging configuration is evenly divided into N parts. Therefore, the average loss efficiency can be defined as the following formula:

$${P}_{loss}^{avg} = \frac{{\sum }_{i = 1}^{N} \frac{{I}_{bat} ( {t}_{i} ) {V}_{bat} ( {t}_{i} )}{{η}_{sys} ( {t}_{i} )} [ 1 - {η}_{sys} ( {t}_{i} ) ]}{N} .$$

The purpose of the LC matching network is to improve the load conditions of the coupled coil. The Ls should be designed to partially compensate for the non-negligible reactance in the input impedance of the Class-E rectifier operating at MHz, namely:

$${L}_{s} = - \frac{{X}_{rec}}{ω} {{\vert}_{{V}_{bat}^{nom} , {I}_{bat}^{nom}} = \frac{1}{π} [ \frac{a + b}{{ω}^{2} {C}_{r}} ] \vert}_{{V}_{bat}^{nom} , {I}_{bat}^{nom}} , \\ a = π ( 1 - D ) + 2 π ( 1 - D ) sin {φ}_{1} sin ( {φ}_{1} - 2 πD ) , \\ b = sin 2 π D + \frac{1}{4} sin ( 2 {φ}_{1} - 4 π D ) - \frac{1}{4} sin 2 {φ}_{1} ,$$

Then, the ESR of the rLs can be calculated via Ls;

$${r}_{{L}_{s}} = \frac{ω {L}_{S}}{{Q}_{{L}_{s}}} = \frac{1}{{πQ}_{{L}_{s}}} [ \frac{a + b}{ω {C}_{r}} ] {\vert}_{{V}_{bat}^{nom} , {I}_{bat}^{nom}} ,$$

Among them:

Ls is the first shunt unit 31;

Cr is the third resonant unit 51;

ϕ₁ is the current value for the initial stage;

ω is the operating frequency;

D is the working cycle of rectification;

V_{bat}^{nom} is the battery voltage, that is, the voltage of the power-storage element 7;

I_{bat}^{nom} is the current when charging;

Xrec can be determined via Cr, V_{bat}^{nom}, and I_{bat}^{nom};

QLs is the quality factor of Ls. Note that the candidate Cr is used to calculate Ls in the design optimization process below. The design parameters in the following optimizations, the capacitances are finally determined as follows;

x=[Cₛ,C₀,Cᵣₓ,Cₚ,Cᵣ],

Here x is a vector. Cs and C0 are parallel and series capacitors of class-E PA;

Crx is a compensation capacitor of the receiving coil (first resonant unit 2);

Cp is a parallel capacitor of the matching network (second resonant unit 32);

Cr is a parallel capacitor of the class-E rectifier (third resonant unit 51);

Due to the non-negligible Xrec, Crx is also considered a design parameter which can further reduce the effects of Xrec throughout the charging cycle. Therefore, unlike the conventional designs, the resonance of the receiving coil is not presupposed here.

The constant parameters (Pcon) in the optimized design of the wireless charging system are as follows:

p_{con}=[Lₜₓ,Lᵣₓ,V_{f},r_{D}_{ᵣ},rₜₓ,rᵣₓ,ωk].

The problem of design optimization is expressed as follows:

$${min}_{x} {P}_{loss}^{avg} ( x , {p}_{con} , {I}_{bat} , {V}_{bat} ) s . t . x ∈ ( {x}^{lower} , {x}^{upper} ) , \\ {min}_{x} \text{:} \text{When X is the minimum value;}$$

$${P}_{loss}^{avg} \text{is the average power loss;}$$

X^{lower} and X^{upper} are the lower and upper feasible ranges of X, respectively;

I and V represent the recorded battery charging curve;

Ltx and Lrx represent transmit and receive coils, respectively;

rtx and rrx are the equivalent serial resistance (ESR) of Ltx and Lrx;

Ctx and Crx are compensation capacitors;

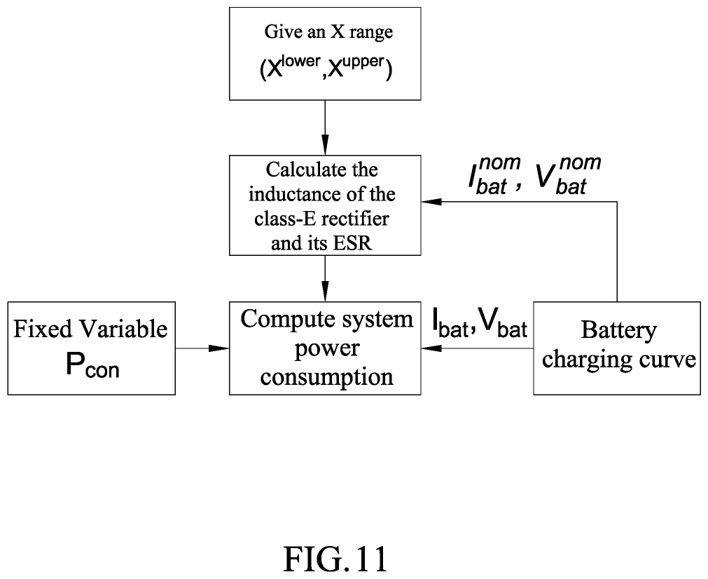

Therefore, the experimental results of system efficiency can be derived through the above formula, and FIG. 11 can be obtained. The relationship between the design parameters and the constants and the battery charging curve will be given by a variable X in a certain range cooperated with the I and V values given by battery charging curve can be used to calculate the inductance and the ESR of the class-E rectifier, and then the system power consumption is calculated by matching the fixed variable Pcon.

Therefore, the key to improve the conventional technology of the low-energy-consumption and high-frequency wireless charging system of the lithium battery of the present invention is to use the resonance-tuning module 3 to stabilize the charging curve, and to achieve the low power loss and high efficiency Class-E wireless fast charging for the lithium battery with a simple design.

1: A low-energy-consumption high-frequency wireless charging system for a lithium battery, which comprises:
a power-supply module;
a first resonant unit directly connected in series with the power-supply module;
a resonance-tuning module located at one side of and electrically connected to the first resonant unit, wherein the resonance-tuning module comprises a second resonant unit and a first shunt unit electrically connected with the second resonant unit;
a second shunt unit electrically connected with the resonance-tuning module, wherein one end of the second shunt unit is electrically connected with the first shunt unit for current reflow;
a rectifier module located at one side of and electrically connected to the first shunt unit for adjusting the current flow direction;
a third resonant unit, wherein the third resonant unit is connected in parallel with the rectifier module, and is configured to control the frequency of the rectifier module;
a voltage stabilizing module, wherein one end of the voltage stabilizing module is electrically connected with the rectifier module;
a power-storage element connected in parallel with the voltage stabilizing module; and
a grounding portion located at one side of and electrically connected to the power-storage element.

2: The low-energy-consumption high-frequency wireless charging system for a lithium battery according to claim 1, wherein the power-supply module is a power supply provided by a wireless connection method.

3: The low-energy-consumption high-frequency wireless charging system for a lithium battery according to claim 1, wherein the first resonant unit, the second resonant unit, and the third resonant unit are capacitance.

4: The low-energy-consumption high-frequency wireless charging system for a lithium battery according to claim 1, wherein the voltage stabilizing module comprises at least one voltage stabilizing capacitor.

5: The low-energy-consumption high-frequency wireless charging system for a lithium battery according to claim 1, wherein the first shunt unit and the second shunt unit are inductance.

6: The low-energy-consumption high-frequency wireless charging system for a lithium battery according to claim 1, wherein the power-storage element is a DC battery.
